(19) United States
(12) Patent Application Publication
(10) Pub. No.: US 2025/0292529 A1
(43) Pub. Date: Sep. 18, 2025

(54) IMAGE PROCESSING APPARATUS, IMAGE PROCESSING METHOD, AND NON-TRANSITORY COMPUTER READABLE MEDIUM

(71) Applicant: CANON KABUSHIKI KAISHA, Tokyo (JP)

(72) Inventor: Toru TANAKA, Chiba (JP)

(21) Appl. No.: 19/079,867

(22) Filed: Mar. 14, 2025

(30) Foreign Application Priority Data
Mar. 18, 2024 (JP) 2024-042589

(51) Int. Cl. G06V 10/25; G06V 10/26

(52) U.S. Cl. CPC G06V 10/25; G06V 10/267; G06V 2201/031

(57) ABSTRACT

An image processing apparatus includes a processor, and a memory storing a program which, when executed by the processor, causes the image processing apparatus to execute image acquisition processing of acquiring a plurality of images in which a site of a subject is imaged, execute initial region acquisition processing of acquiring information about a plurality of initial regions associated with the site by using a number of images among the plurality of images, and execute detailed region acquisition processing of acquiring information about a detailed region associated with the site in any of the plurality of images on the basis of the information about the plurality of initial regions.

### BACKGROUND OF THE INVENTION

### Field of the Invention

The present invention relates to an image processing apparatus, an image processing method, and a non-transitory computer readable medium.

### Description of the Related Art

In the medical field, there is a technique of supporting understanding of the structure and state of the heart by acquiring a region of a heart cavity of the heart from medical images captured with various modalities, displaying the region of the heart cavity, and outputting a measurement value measured from the region of the heart cavity.

Japanese Patent Application Publication No. 2017-004441 discloses a technique of efficiently acquiring a region of the entire object by acquiring an initial region included in the object from a low-resolution image and acquiring a region including the contour of the object in detail from a high-resolution image on the basis of the initial region.

In the technique disclosed in Japanese Patent Application Publication No. 2017-004441, however, a detailed region of the object may not be acquired appropriately from the image if there is an error in the acquired initial region.

### SUMMARY OF THE INVENTION

The technique of the present disclosure has been made in view of the above, and has an object to improve the accuracy in extracting a region related to a site of a subject from an image obtained by imaging the site.

According to some embodiments, an image processing apparatus includes a processor, and a memory storing a program which, when executed by the processor, causes the image processing apparatus to execute image acquisition processing of acquiring a plurality of images in which a site of a subject is imaged, execute initial region acquisition processing of acquiring information about a plurality of initial regions associated with the site by using a number of images among the plurality of images, and execute detailed region acquisition processing of acquiring information about a detailed region associated with the site in any of the plurality of images on the basis of the information about the plurality of initial regions.

According to some embodiments, an image processing apparatus includes a processor, and a memory storing a program which, when executed by the processor, causes the image processing apparatus to execute image acquisition processing of acquiring a plurality of images in which a site of a subject is imaged, execute first information acquisition processing of acquiring information about a plurality of first regions associated with the site by using a number of images among the plurality of images, and execute second information acquisition processing of acquiring information about a second region on the basis of the information about the plurality of first regions, the second region associated with the site in any of the plurality of images and being higher in a degree of coincidence with a shape of the site than the first regions.

Further features of the present invention will become apparent from the following description of exemplary embodiments with reference to the attached drawings.

### BRIEF DESCRIPTION OF THE DRAWINGS

FIG. 1 illustrates the configuration of an image processing system according to a first embodiment.

FIG. 2 illustrates the functional configuration of a control unit of an image processing apparatus according to the first embodiment.

FIG. 3 is a flowchart illustrating an example of a process executed by the image processing apparatus according to the first embodiment.

FIGS. 4A to 4D each illustrate a region obtained from an image in the first embodiment.

FIG. 5 illustrates an example of display of a detailed region in the first embodiment.

### DESCRIPTION OF THE EMBODIMENTS

An embodiment of the image processing apparatus disclosed herein will be described below with reference to the drawings. The same or equivalent constituent elements, members, and processes illustrated in the drawings are denoted by the same reference numerals, and redundant descriptions are omitted. In each drawing, some constituent elements, members, and processes may be omitted.

### First Embodiment

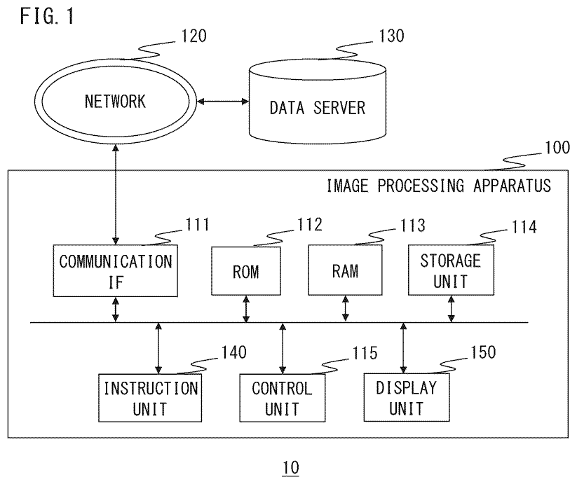

An image processing system according to a first embodiment of the present disclosure is described. FIG. 1 illustrates the configuration of an image processing system 10 according to the present embodiment. As illustrated in FIG. 1, the image processing system 10 includes an image processing apparatus 100 and a data server 130. The image processing apparatus 100 is communicably connected to the data server 130 by way of a network 120.

In the image processing system 10 according to the present embodiment, the image processing apparatus 100 acquires a plurality of initial regions of heart cavities by using a plurality of three-dimensional images obtained by imaging the heart, and acquires a detailed region of the heart cavities b using a predetermined three-dimensional image on the basis of the plurality of initial regions. Here, the heart cavities are cavities of the heart, and include a left atrium, a left ventricle, a right atrium, a right ventricle. Then, the image processing apparatus 100 displays the acquired detailed region of the heart cavities, or provides measurement values measured from the detailed region of the heart cavities to a user. This enables the user to easily understand the structure and state of the heart through the image processing apparatus 100.

The configuration of the image processing system 10 will be described below with reference to FIG. 1. The image processing system 10 includes, as functional components thereof, the image processing apparatus 100, the network 120, and the data server 130. The network 120 includes, for example, a LAN (Local Area Network) or a WAN (Wide Area Network).

The data server 130 is a picture archiving and communication system (PACS) that holds and manages medical images and information associated with the medical images. The image processing apparatus 100 may acquire the medical images stored in the data server 130 via the network 120. The data server 130 stores images captured by medical image capturing apparatuses (modalities), and transmits the images to an apparatus connected to the network 120 in response to a request from the apparatus. The data server 130 includes a database that stores, along with the received images, various data associated with the images.

In the present embodiment, the three-dimensional images will be described as images captured by an X-ray computed tomography (CT) apparatus, but other modalities may be used to capture the three-dimensional images. Examples of the modalities include, in addition to X-ray CT apparatuses, magnetic resonance imaging (MRI) apparatuses and single photon emission computed tomography (SPECT) apparatuses. Other examples of the modalities include positron emission tomography (PET) apparatuses, ultrasound diagnostic apparatuses, and optical coherence tomography (OCT) apparatuses. The image processing apparatus 100 according to the present embodiment is applicable to three-dimensional images acquired by various modalities. Although the present embodiment describes a case where the image processing apparatus 100 processes the three-dimensional images, the image processing apparatus 100 is not limited to processing the three-dimensional images, and may execute the following process on two-dimensional images such as long axis images of the heart cavity to be processed, for example.

The image processing apparatus 100 is an apparatus that performs image processing according to the embodiment. The image processing apparatus 100 is an apparatus that causes a display unit 150 to display a region and a measurement value acquired by using the three-dimensional images, and functions as a terminal apparatus for image reading that is operated by a user such as a doctor. The image processing apparatus 100 includes a communication interface (IF) 111, a read only memory (ROM) 112, a random access memory (RAM) 113, a storage unit 114, and a control unit 115.

The communication IF 111 (communication unit) is composed of a LAN card or the like, and achieves communication between an external apparatus (e.g., the data server 130, etc.) and the image processing apparatus 100. The ROM 112 is composed of a non-volatile memory or the like, and stores various programs. The RAM 113 is composed of a volatile memory or the like, and temporarily stores various information as data. The storage unit 114 is configured of a hard disk drive (HDD) or the like, and stores various information as data.

An instruction unit 140 is composed of a keyboard, a mouse, and a graphical user interface (GUI) such as a touch panel, and used to input instructions from a user (e.g., a doctor) to the image processing apparatus 100. An image to be processed in the image processing apparatus 100 is input to the image processing apparatus 100 in response to an instruction from a user who operates the instruction unit 140. The selection of the image may not be based on an instruction from a user, and the control unit 115 of the image processing apparatus 100 may automatically select the image to be processed in accordance with a predetermined rule, for example.

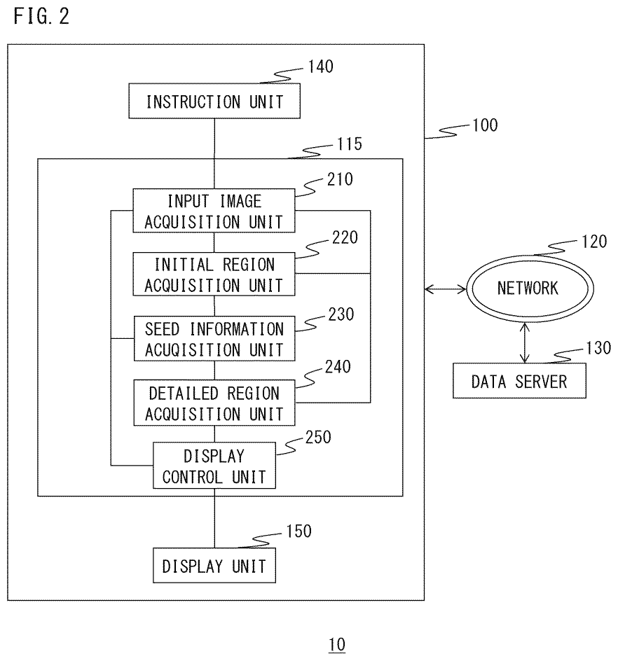

FIG. 2 illustrates the functional configuration of the control unit 115 of the image processing apparatus 100. The control unit 115 is composed of a central processing unit (CPU) or the like, and integrally controls a process in the image processing apparatus 100. The control unit 115 includes, as functional components thereof, an input image acquisition unit 210, an initial region acquisition unit 220, a seed information acquisition unit 230, a detailed region acquisition unit 240, and a display control unit 250.

The input image acquisition unit 210 acquires a plurality of three-dimensional images from the data server 130 via the communication IF (communication unit) 111 and the network 120. The initial region acquisition unit 220 acquires an initial region associated with the heart cavity by using each of a certain number of three-dimensional images among the plurality of three-dimensional images acquired. This allows the initial region acquisition unit 220 to acquire information about a plurality of initial regions associated with the heart cavity by using the plurality of three-dimensional images. The seed information acquisition unit 230 acquires seed information on the basis of the plurality of initial regions acquired. Here, the seed information is information about a rough position at which a region of the heart cavity exists, and is information to be used to acquire a detailed region of the heart cavity, which will be described later. In the present embodiment, the seed information is region information indicating a foreground seed and a background seed, which will be described later. The detailed region acquisition unit 240 acquires, on the basis of the seed information, information about a detailed region associated with the heart cavity by using any three-dimensional image of the plurality of three-dimensional images acquired. In the present embodiment, the initial region acquisition unit 220 and the seed information acquisition unit 230 serve as a first information acquisition unit that acquires information about an initial region as a first region. Meanwhile, the detailed region acquisition unit 240 serves as a second information acquisition unit that acquires information about a detailed region as a second region on the basis of the information about the initial region. The second region, which is the detailed region, has a higher degree of coincidence with the shape of the “heart cavity” associated with the anatomical site to be extracted than the first region, which is the initial region initially extracted. Put differently, the second region, which is the detailed region, may be more likely to coincide with the shape of the “heart cavity” associated with the anatomical site to be extracted than the first region, which is the initial region initially extracted.

The display control unit 250 generates an image to be displayed on the display unit 150 using the acquired detailed region. The display control unit 250 controls display of the generated image on the display unit 150. The display unit 150 is composed of any display apparatus such as a liquid crystal display (LCD) or a cathode ray tube (CRT), and displays the image, various information, etc., acquired by the control unit 115 to the user. Specifically, the display unit 150 displays an input image and a detailed region of the heart cavity acquired by the image processing apparatus 100.

Each constituent element of the image processing apparatus 100 described above functions in accordance with a computer program. For example, the function of each constituent element is implemented by the control unit 115 (CPU) reading and executing a computer program stored in the ROM 112, the storage unit 114, or the like using the RAM 113 as a work area. Some or all of the functions of the constituent elements of the image processing apparatus 100 may be implemented using a dedicated circuit. Some of the functions of the constituent elements of the control unit 115 may be implemented using a cloud computer.

For example, at least some of the functions of the constituent elements of the control unit 115 may be implemented by communicably connecting a computing apparatus located outside of the image processing apparatus 100 to the image processing apparatus 100 via the network 120, and the image processing apparatus 100 transmitting and receiving data to and from the computing apparatus.

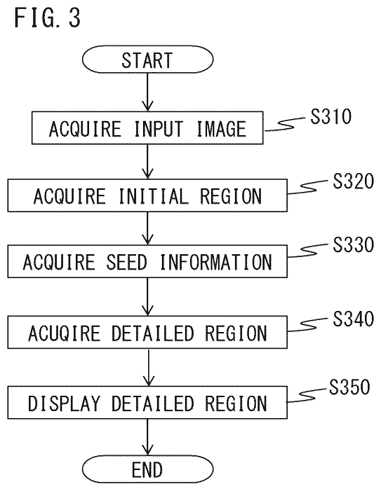

Next, an example of a process executed by the image processing apparatus 100 in the present embodiment will be described with reference to FIG. 3. FIG. 3 is a flowchart illustrating a process executed by the control unit 115 of the image processing apparatus 100. In the present embodiment, an image processing method of the present disclosure is implemented by the control unit 115 executing the following steps. In the present embodiment, it is assumed that the image processing apparatus 100 processes cardiac CT images obtained by imaging the heart of a subject with an X-ray CT apparatus.

(S310: Acquisition of Input Images) In step S310, when the user provides an instruction to acquire a plurality of three-dimensional images via an operation of the instruction unit 140, the input image acquisition unit 210 acquires, from the data server 130, a plurality of cardiac CT images obtained by imaging the heart of the subject specified by the user. The input image acquisition unit 210 outputs the plurality of cardiac CT images acquired to each of the initial region acquisition unit 220, the seed information acquisition unit 230, the detailed region acquisition unit 240, and the display control unit 250.

In the present embodiment, the cardiac CT images are images obtained from a moving image (four-dimensional (4D) CT image) composed of images obtained by imaging (i.e., imaging over time) the state of different phases of the heart whose shape changes periodically. The plurality of cardiac CT images may be a plurality of cardiac CT images obtained by imaging the same subject at different dates and times, or may be a dynamic CT image obtained by imaging the same subject at different contrast timings, or a combination of a contrast CT image and a non-contrast CT image. The plurality of images acquired are not limited to images obtained by imaging the heart of the same subject, and may be images obtained by imaging the heart of different subjects. The plurality of cardiac CT images are not limited to images captured with the same modality, and may be images captured with different modalities. The plurality of cardiac CT images are not limited to images obtained by imaging the same subject over time, and may be images obtained by imaging the subject at the same time with different means.

The input image acquisition unit 210 may also function as an image selection unit that selects two or more images, by using which an initial region is acquired, by using the plurality of three-dimensional images acquired. For example, the input image acquisition unit 210 can select a plurality of images with higher similarity in the form or phase of the left atrium on the basis of form information or phase information on the left atrium in the plurality of three-dimensional images acquired. The similarity in the form or phase may also be referred to as the adaptability, the degree of coincidence in the shape, etc. The similarity in the form or phase can be put into an objective numerical value by using a known statistical index such as the Jaccard coefficient, the Dice coefficient, and the Simpson coefficient.

(S320: Acquisition of Initial Regions) In step S320, the initial region acquisition unit 220 acquires an initial region associated with the heart cavity by using each image of a certain number of three-dimensional images, here, at least two or more three-dimensional images, among the plurality of cardiac CT images acquired in step S310. The initial region acquisition unit 220 outputs information on a plurality of initial regions acquired by using the plurality of cardiac CT images to the seed information acquisition unit 230. While the process is described using the left atrium as an example of the heart cavity in the present embodiment, the process is also applicable to the other heart cavities (left ventricle, right atrium, right ventricle) of the heart.

In the present embodiment, the initial region acquisition unit 220 acquires an initial region of the left atrium by using each image of three-dimensional images of a plurality of cardiac phases included in a 4D CT image. Here, acquisition of an initial region by using three-dimensional images can be achieved using a known image analysis technique. For example, as an example of a technique in which a machine learning model is used, the initial region acquisition unit 220 can estimate a region of the left atrium from the cardiac CT image using UNet which is a type of deep learning as the machine learning model, and determine the estimated region as the initial region.

In the present embodiment, the image of the initial region acquired by the initial region acquisition unit 220 is a mask image. Here, the mask image is a binary image of the same image coordinate system as the cardiac CT image, and is an image in which a pixel value (e.g., 1) of the foreground is stored in pixels indicating an initial region of the left atrium and a pixel value (e.g., 0) of the background is stored in regions other than the initial region. The initial region acquisition unit 220 may directly acquire a mask image that is a binary image using UNet. Instead, the initial region acquisition unit 220 may acquire a mask image that is a binary image by executing threshold processing or the like after acquiring an image in which a value representing left atrium likelihood (probability of presence of the left atrium) is stored in the pixel value of each pixel using UNet. Alternatively, the initial region acquisition unit 220 may acquire an image in which a pixel value corresponding to the probability of presence of the left atrium is stored in each pixel, rather than a binary mask image.

Acquisition of an initial region is not limited to a method in which UNet is used, and may be achieved by using any other machine learning model or using a known image region extraction technique. For example, the initial region acquisition unit 220 may acquire an initial region of the left atrium by applying a statistical shape model to a cardiac CT image of the subject. The initial region acquisition unit 220 projects the region of the left atrium indicated by the statistical shape model onto the image coordinate system of the subject on the basis of the statistical shape model representing the statistical tendency of the region of the left atrium calculated from cardiac CT images of multiple cases and the result of registration of the cardiac CT image of the subject with respect to the left atrium. Then, the initial region acquisition unit 220 generates a mask image using a region obtained by projection as the initial region. Alternatively, information about the region of the left atrium of the subject may be stored in advance in the data server, and the initial region acquisition unit 220 may read and acquire such information from the data server, and acquire an initial region on the basis of the acquired information.

In the present embodiment, an initial region is acquired by using each of at least two or more images of the plurality of cardiac CT images acquired by the input image acquisition unit 210. The seed information to be acquired in the subsequent step S330 is preferably similar in the form of the left atrium among the plurality of cardiac CT images by using which an initial region is acquired. Thus, in the case of a 4D CT image obtained by consecutively imaging a pulsating heart over time, for example, a cardiac CT image similar in the form of the left atrium is obtained by acquiring an initial region by using each of images of a predetermined frame and frames before and after the predetermined frame.

When acquiring a 4D CT image of the heart, it is also possible to acquire an initial region by using each of images of a plurality of frames with close cardiac phases, even if such images are of different cycles in the cardiac cycle. It is not always necessary that the plurality of cardiac CT images by using which an initial region is acquired should be images of similar cardiac phases. For example, such images may be images of a plurality of cardiac phases similar in the form (such as shape or volume) of the left atrium, such as a cardiac phase between the diastolic and systolic phases in a period from the diastolic phase to the systolic phase and a cardiac phase between the diastolic and systolic phases in a period from the systolic phase to the diastolic phase.

The initial region acquisition unit 220 may automatically determine an image by using which an initial region is acquired by performing image analysis on the plurality of three-dimensional images acquired. For example, the initial region acquisition unit 220 may calculate the similarity of images between an acquired image of a predetermined cardiac phase and images of other cardiac phases, and acquire an initial region by using only an image of a highly similar cardiac phase. This allows the initial region acquisition unit 220 to selectively acquire an image similar in the form of the left atrium.

The initial region acquisition unit 220 may determine an image by using which an initial region is acquired in accordance with the image quality of each image. For example, the initial region acquisition unit 220 may calculate a feature amount indicating the sharpness of each image constituting the plurality of cardiac CT images, and acquire an initial region by using only a highly sharp image of a cardiac phase. This allows the initial region acquisition unit 220 to acquire an initial region by using an image with less artifacts such as motion artifacts and high image quality. It is not always necessary to limit the image by using which an initial region is acquired, and the initial region acquisition unit 220 may acquire an initial region by using images of all the cardiac phases constituting the plurality of cardiac CT images input.

(S330: Acquisition of Seed Information) In step S330, the seed information acquisition unit 230 acquires seed information on the basis of the plurality of initial regions acquired in step S320. Then, the seed information acquisition unit 230 outputs the acquired seed information to the detailed region acquisition unit 240.

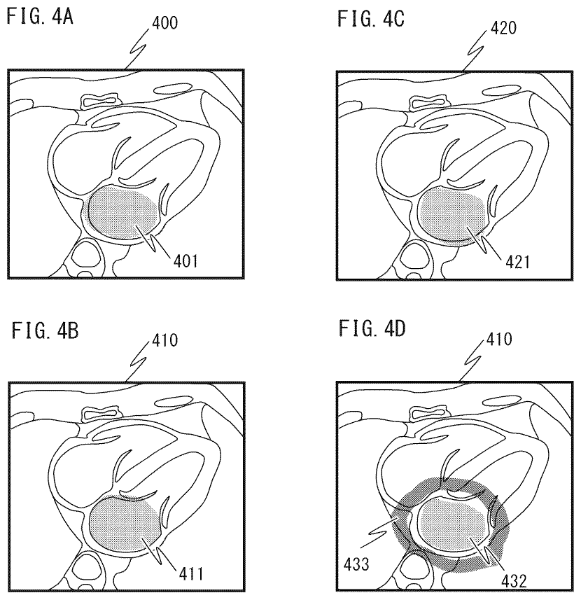

In the present embodiment, the seed information acquisition unit 230 acquires information on a foreground seed and a background seed as the seed information. The foreground seed is a region in which the plurality of initial regions acquired in step S320 overlap. On the other hand, the background seed is a region not included in any of the plurality of initial regions. First, an example of a process of acquiring information on the foreground seed will be specifically described with reference to FIGS. 4A to 4D.

In FIGS. 4A to 4D, for simplicity of description, a predetermined tomographic image (two-dimensional image) included in the three-dimensional image to be processed by the image processing apparatus 100 will be described as an example. However, the present embodiment is applicable to not only two-dimensional images but also three-dimensional images.

Images 400, 410, 420 illustrated in FIGS. 4A to 4C are tomographic images at the same slice position included in three-dimensional images of consecutive cardiac phases, among the 4D CT image acquired in step S310. In step S320, initial regions 401, 411, 421 of the left atrium (regions of the mask image in which the pixel value of the foreground is stored) are acquired by using the images 400, 410, 420, respectively. Then, the seed information acquisition unit 230 acquires a region in which the initial regions 401, 411, 421 overlap on the image space as the foreground seed. FIG. 4D illustrates a foreground seed 432 acquired by the seed information acquisition unit 230 by using the image 410 as a predetermined image using the initial regions 401, 411, 421.

In general, when extracting a region of an object from an image, a portion within the object tends to be extracted with higher accuracy than a portion near the peripheral edge of the object. Thus, the region acquired in step S320 as the initial region by using a plurality of images of cardiac phases with similar shapes of the left atrium has a high probability (likelihood or internal likelihood) of being a region included in the left atrium. Therefore, the seed information acquisition unit 230 can specify a region with high likelihood, of the region included in the left atrium, as the foreground seed. Here, the likelihood representing the probability of being included in the left atrium in the image by using which an initial region is acquired may be rephrased as indicating the degree of probability that a region of interest in the image is included in the left atrium. That is, the likelihood representing the probability of being included in the left atrium in the image by using which an initial region is acquired being equal to or greater than a predetermined threshold may be rephrased as the probability that a region of interest in the image is included in the left atrium is equal to or greater than a predetermined probability.

Specifically, it is assumed that, in an image of a predetermined cardiac phase, for example, the boundary of the region of the left atrium is unclear due to the effect of motion artifacts or uneven CT values due to a contrast agent near the peripheral edge of the left atrium. In this case, there may occur so-called overextraction, in which a region other than the original region of the left atrium is also extracted as the initial region in the peripheral edge portion in which the boundary is not clear. However, even if the peripheral edge portion of the left atrium is overextracted in an image of a certain cardiac phase, an initial region may be appropriately extracted in an image of another cardiac phase because of having less artifacts or different variations in CT values due to a contrast agent. According to the present embodiment, by acquiring a region in which the initial region of the left atrium overlaps between a predetermined phase and another phase, the region overextracted as described above can be excluded, and a region included in the left atrium in an image of a predetermined cardiac phase can be specified as the foreground seed. That is, the seed information acquisition unit 230 can acquire information on the foreground seed by specifying a region having a high probability (likelihood) of being inside of the left atrium as the foreground seed using three-dimensional images through the above process.

As an example, the seed information acquisition unit 230 acquires a first likelihood distribution of the likelihood of being the region of the left atrium for the plurality of initial regions acquired in step S320. In the first likelihood distribution, the likelihood is higher as the probability of being inside of the left atrium in the initial region is higher. The first likelihood distribution for the initial regions can be calculated using a well-known technique, and therefore detailed description of the calculation of the likelihood distribution is omitted here. In the first likelihood distribution, the likelihood for a portion in which at least two regions of the plurality of initial regions overlap is higher than the likelihood for a portion in which the at least two regions do not overlap. Thus, the first likelihood distribution indicates that a portion in which the plurality of initial regions overlap is more likely to be inside of the left atrium. This allows the seed information acquisition unit 230 to specify a portion in which the likelihood in the acquired first likelihood distribution is equal to or greater than a threshold as the initial region, and acquire information about the initial region, for example.

Next, an example of a process of acquiring information on the background seed in the present embodiment will be described with reference to FIGS. 4A to 4D. In the present embodiment, the seed information acquisition unit 230 specifies, from the image 410 as a predetermined image, a region not included in any of the initial regions 401, 411, 421 on the image space as a background seed 433. The region not included in any of the initial regions has a high probability (likelihood or external likelihood) of being a region not included in the left atrium. Thus, the seed information acquisition unit 230 specifies a region with high likelihood, of the region not included in the left atrium, as the background seed, and acquires information about the background seed.

As described in the above description of the method of acquiring the foreground seed, the boundary of the region of the left atrium may not be clear in an image of a predetermined cardiac phase for various reasons. At this time, an initial region may be extracted in a state in which the original region of the left atrium is missing in the peripheral edge portion in which the boundary is not clear. However, even if an initial region is extracted in a state in which the peripheral edge portion of the left atrium is missing in an image of a certain cardiac phase, an initial region may be appropriately extracted in an image of another phase because of having less artifacts or different variations in CT values due to a contrast agent. According to the present embodiment, by acquiring a region not included in any of the initial regions of the left atrium between a predetermined phase and another phase, the region that is missing as described above can be excluded, and a region not included in the left atrium in an image of a predetermined phase can be specified as the background seed. That is, a region having a high probability (likelihood) of being outside of the left atrium can be specified as the background seed for each three-dimensional image through the above process.

As an example, the seed information acquisition unit 230 determines the left atrium as a target site, and acquires a second likelihood distribution of the likelihood of being a region outside of the site for the plurality of initial regions acquired in step S320. In the second likelihood distribution, unlike the above first likelihood distribution, the likelihood is higher as the probability of being outside of the left atrium in the initial region is higher. The second likelihood distribution for the initial regions can be calculated using a well-known technique, and therefore detailed description of the calculation of the likelihood distribution is omitted here. In the second likelihood distribution, the likelihood for a portion not included in any of at least two regions of the plurality of initial regions is higher than the likelihood for a portion included in any of the at least two regions. Thus, the second likelihood distribution indicates that a portion not included in the plurality of initial regions is more likely to be outside of the left atrium. This allows the seed information acquisition unit 230 to specify a portion in which the likelihood in the acquired second likelihood distribution is equal to or greater than a threshold as a portion outside of the left atrium, and acquire information about the portion outside of the left atrium as information about the initial region, for example.

While the method of acquiring seed information (information on the foreground seed 432 and the background seed 433) in the image 410 has been described in the present embodiment, seed information on an image of another cardiac phase can also be acquired by a method similar to that described above. Alternatively, the acquired seed information of the image 410 may also be used as seed information of an image of another phase. This improves the efficiency of the process, since it is only necessary to acquire seed information by using only one of the plurality of three-dimensional images acquired by the input image acquisition unit 210.

The above-described process of acquiring a region in which a plurality of initial regions overlap in the image space as information on the foreground seed is a process that is relatively simple and efficient, among various processes of acquiring information on the foreground seed. On the other hand, the shape of the left atrium is different among a plurality of cardiac CT images. Therefore, even if an initial region of the left atrium is successfully appropriately acquired by using an image of a certain cardiac phase, the region of the same image coordinate of another cardiac phase is not necessarily included in the left atrium. For example, a region included in the left atrium in an image of a certain cardiac phase may be located outside of the left atrium in an image of another cardiac phase. In this case, if such a position is overextracted as the initial region, the overextracted region may not be excluded from the foreground seed by the above method. Thus, there is contemplated a method of using deformation information of an initial region that can be acquired by registration of a plurality of images associated with different phases of a region (e.g., the left atrium) that periodically changes in shape in the images such that the contour position or the like of the left atrium is registered, for example. In this case, the shape of the region associated with the left atrium is changed on the basis of the deformation information obtained by acquiring the initial region of a certain cardiac phase and the initial region of another cardiac phase, and the region overlapping with the region is acquired as the foreground seed. This allows more accurate acquisition of the foreground seed included in the left atrium of an image of a predetermined cardiac phase.

Similar to the foreground seed, the background seed may be acquired using deformation information of an initial region that can be acquired by registration of images such that the contour position or the like of the left atrium is registered. In this case, a region not included in any of the initial region of a certain cardiac phase and a deformed region obtained by deforming the initial region of another cardiac phase may be acquired as the background seed. This allows more accurate acquisition of the background seed not included in the left atrium of an image of a predetermined cardiac phase.

Here, registration of an object (such as the left atrium) between a plurality of three-dimensional images can be achieved using a known method. The registration is performed so as to increase the similarity of the object between the images after deformation due to the registration, for example. In this case, a deformation model based on a radial basis function such as Thin Plate Spline (TPS) or a known deformation model such as Free Form Deformation (FFD) can be used as an image deformation model. As an example of a technique in which a machine learning model is used, images may be registered using VoxelMorph which is a type of deep learning.

Alternatively, a region obtained by shrinking a region in which a plurality of initial regions overlap may be used as the foreground seed, or a threshold for the pixel value determined in advance may be used to exclude a region with a pixel value less than the threshold, of a region in which a plurality of initial regions overlap, from the foreground seed. Here, the threshold may be set on the basis of CT values of the left atrium acquired for common contrast CT images. The threshold is not always limited to being set in advance, and the control unit 115 may adaptively set a threshold on the basis of the distribution of CT values (e.g., the average value or the median value) in a plurality of initial regions. This is expected to have the effect that an overextracted region of the left atrium can be more appropriately excluded compared to the method of simply acquiring a region in which initial regions overlap in the image space.

Similarly, a region obtained by shrinking a region not included in any of the plurality of initial regions may be used as the background seed, or a threshold for the pixel value determined in advance may be used to exclude a region with a pixel value equal to or more than the threshold, of a region not included in any of the plurality of initial regions, from the background seed. This is expected to have the effect that a region included in the left atrium can be more appropriately excluded compared to the method of simply acquiring a region not included in any of the plurality of initial regions in the image space.

In the case of a plurality of cardiac CT images obtained by imaging the heart of different subjects, the difference in position and shape of the heart on the image space between the images is large compared to a plurality of cardiac CT images obtained by imaging the same patient. Thus, it is preferable to use deformation information that can be acquired by registration of images in the same manner as in the above method, and specify a region of overlap between a region obtained by deforming an initial region of another image on the basis of the deformation information and an initial region of a predetermined image as the foreground seed. This allows an overextracted region in the predetermined image to be excluded from the foreground seed.

When acquiring an initial region by using a plurality of cardiac CT images obtained by imaging the heart of different subjects, the difference in position of the contour of the heart deformed on the basis of deformation information between the images may be large compared to when acquiring an initial region by using a plurality of cardiac CT images obtained by imaging the same subject. In this case, there is a possibility that a region overextracted in a predetermined image cannot be excluded from the foreground seed, even if a region overlapping between a plurality of initial regions is determined as the foreground seed. Thus, when acquiring an initial region by using a plurality of cardiac CT images obtained by imaging the heart of different subjects, it is preferable to also perform a process of determining a region obtained by shrinking a region in which a plurality of initial regions overlap as the foreground seed, for example. This makes it possible to more accurately acquire the foreground seed included in the left atrium of a predetermined image, even in the case of a plurality of cardiac CT images obtained by imaging the heart of different subjects. When acquiring information on the background seed, as in the case of the foreground seed, an initial region can be acquired more accurately by using cardiac CT images of different subjects.

The initial regions that are used to acquire the foreground seed and the background seed may be all the initial regions acquired in step S320, or may be only some of the initial regions. When acquiring seed information using only some of the initial regions, the seed information acquisition unit 230 may calculate the degree of abnormality of each initial region, and exclude an initial region with a high degree of abnormality from the initial regions by using which seed information is acquired. Here, the degree of abnormality is an index indicating a difference between an initial region and another initial region in the volume of the initial region, the position (e.g., the position of the center of gravity) of the initial region in the image space, or the like, for example. When the degree of abnormality is high, it can be considered that acquisition of the initial regions has probably failed.

It is not always necessary that the plurality of initial regions that are used to acquire information on the foreground seed and the background seed should be initial regions acquired by using the same image. That is, an image by using which the initial region that is used to acquire information on the foreground seed is acquired and an image by using which the initial region that is used to acquire information on the background seed is acquired may be images different from each other.

In the present embodiment, it is assumed that information on the foreground seed is acquired on the basis of a region in which all of the plurality of initial regions overlap. However, a region in which a certain number of initial regions, among the plurality of initial regions that are used to acquire information on the foreground seed, or a certain percentage of initial regions overlap may be used as the foreground seed. For example, a region in which two or more initial regions overlap may be used as the foreground seed, or a region in which half (50%) or more of the plurality of initial regions that are used to acquire the foreground seed overlap may be used as the foreground seed.

Similarly, a region not included in any of the plurality of initial regions that are used to acquire the background seed may be used as the background seed. Alternatively, a region not included in a certain number of initial regions, among the plurality of initial regions that are used to acquire the background seed, or a certain percentage of initial regions may be used as the background seed. For example, a region not included in two or more initial regions may be used as the background seed, or a region not included in half (50%) or more of the plurality of initial regions that are used to acquire the background seed may be used as the background seed.

In step S320, it is assumed that an image is acquired in which a value indicating the probability of presence of an object (such as the left atrium) is stored as a pixel value in each pixel of the initial region. In this case, the seed information acquisition unit 230 may calculate a statistical value of probability based on the pixel value of each pixel, and acquire seed information on the basis of the calculated statistical value. For example, the seed information acquisition unit 230 may determine whether or not the sum or average value of the probability of presence of the object is equal to or greater than a threshold at corresponding pixel positions in the plurality of initial regions, and specify a pixel position at which it is determined that the sum or average value is equal to or greater than the threshold as the foreground seed. Further, the seed information acquisition unit 230 may determine whether or not the sum or average value of the probability of presence of the object is less than a threshold at corresponding pixel positions in the plurality of initial regions, and specify a pixel position at which it is determined that the sum or average value is less than the threshold as the background seed.

It is not always necessary to acquire both the foreground seed and the background seed by the above method, and information on either one of the foreground seed and the background seed may be acquired by the above method, and information on the other seed may be acquired by a method other than the above method. For example, the seed information acquisition unit 230 may acquire information on the foreground seed by any of the methods described above, and specify a region input by the user via the instruction unit 140 as the background seed. Alternatively, information about the background seed may be stored in advance in the data server 130, and the seed information acquisition unit 230 may acquire the information about the background seed from the data server 130 and specify the background seed on the basis of the acquired information.

It is not always necessary to acquire information on the background seed, and the seed information acquisition unit 230 may omit the above process of acquiring information on the background seed. In this case, the processing time required to acquire information on the background seed can be reduced, and the seed information acquisition unit 230 outputs only the acquired information on the foreground seed to the detailed region acquisition unit 240.

(S340: Acquisition of Detailed Region) In step S340, the detailed region acquisition unit 240 acquires information about a detailed region associated with the heart cavity by using a predetermined image of the images acquired in step S310 using the seed information acquired in step S330 on the basis of information on the initial regions. Then, the detailed region acquisition unit 240 outputs the acquired information about the detailed region to the display control unit 250.

In the present embodiment, a detailed region can be specified from an image by a known segmentation technique. For example, the detailed region acquisition unit 240 can consider each pixel of a predetermined image that is the source of acquisition of a detailed region as a node, and specify a detailed region by graph cut using the foreground seed and the background seed as initial values for each node. Further, the detailed region acquisition unit 240 can specify a region obtained by applying a region extension method or a dynamic contour method to the foreground seed as the detailed region.

Alternatively, the detailed region acquisition unit 240 may specify a detailed region on the basis of the distribution of pixel values included in the region of each of the foreground seed and the background seed in a predetermined image that is the source of acquisition of a detailed region. For example, the detailed region acquisition unit 240 calculates a value (e.g., a median value or an average value) representing each seed on the basis of the distribution of pixel values of each of the foreground seed and the background seed, and acquires a threshold for a pixel value that separates the regions of the two seeds using the calculated value. Then, the detailed region acquisition unit 240 can specify a detailed region on the basis of the acquired threshold. More specifically, the detailed region acquisition unit 240 may determine the distribution of pixel values of the foreground seed and the distribution of pixel values of the background seed as initial clusters (foreground cluster and background cluster), and specify a detailed region on the basis of such clusters using a known method such as the k-means method. At this time, the detailed region acquisition unit 240 may exclude a region included in the background seed acquired in step S330, of the specified detailed region, from the detailed region.

Thus, in step S340, the detailed region acquisition unit 240 acquires a detailed region such that the probability that the left atrium is included inside of the region is higher than that of the initial region, and the probability that the left atrium is included outside of the region is lower than that of the initial region.

The predetermined image that is the source of acquisition of a detailed region is at least one image of the input images acquired in step S310, and may be an image of a cardiac phase by using which an initial region is acquired in step S320, or may be an image of any other cardiac phase. The image that is the source of acquisition of a detailed region may be an image selected from the plurality of input images acquired in step S310 by the user operating the instruction unit 140. Alternatively, the image that is the source of acquisition of a detailed region may be selected on the basis of header information of the input images acquired in step S310. For example, it is assumed that the header information of the input images includes information indicating a cardiac phase. In this case, the detailed region acquisition unit 240 can select, on the basis of the header information, an image with less motion artifacts, such as the systolic end or diastolic end of the cardiac phase, as the image that is the source of acquisition of a detailed region. Alternatively, the detailed region acquisition unit 240 may acquire a detailed region by using images of all the phases of the input images acquired in step S310.

(S350: Display) In step S350, the display control unit 250 performs control so as to display the cardiac CT images acquired in step S310 and the detailed region acquired in step S340 on the display unit 150. Specifically, the display control unit 250 performs control so as to generate an image to be displayed on the display unit 150 on the basis of the cardiac CT images and the detailed region, and display the generated image on the display unit 150. For example, the display control unit 250 performs control so as to generate an image obtained by CG rendering of the detailed region of the heart cavity, and display the generated image on the display unit 150. This allows the user to observe the three-dimensional shape of the heart cavity of the subject.

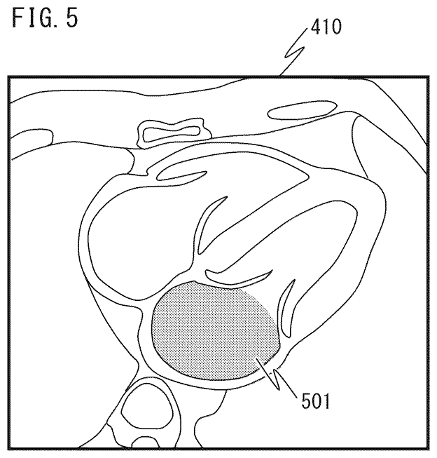

The display control unit 250 can provide a function similar to that of a general medical image viewer. For example, the display control unit 250 selects a two-dimensional (2D) slice image from the cardiac CT image displayed on the display unit 150 in response to an operation of the instruction unit 140 by the user. Then, the display control unit 250 can generate an image obtained by superimposing the detailed region of the heart cavity associated with the selected slice image on the slice image, and display the generated image on the display unit 150. FIG. 5 illustrates an example of an image in which a detailed region is superimposed on a slice image to be displayed on the display unit 150.

In the above description of the present embodiment, information about the detailed region is acquired by using the image 410 which is a slice image. Thus, the display control unit 250 generates an image in which a detailed region 501 is superimposed on the image 410 using the detailed region acquired through the above process on the image 410. Then, the display control unit 250 performs control so as to display the generated image on the display unit 150, thereby displaying an image in which the detailed region 501 is superimposed on the image 410 as illustrated in FIG. 5. This allows the user to accurately specify the region of the left atrium in the image 410 from the detailed region 501 displayed on the display unit 150.

The control unit 115 may perform control so as to store the detailed region acquired in step S340 in the storage unit 114 of the image processing apparatus 100, or may perform control so as to store the detailed region in the data server 130 via the network 120. This allows the control unit 115 to display an image of the detailed region on the display unit 150 with any other medical image viewer, or read the detailed region into any other surgery support software or the like. In this case, the control unit 115 may omit the display process in step S350. The process of displaying and storing the detailed region is not essential, and the control unit 115 may execute any analysis process using the detailed region acquired in step S340. For example, the control unit 115 may calculate or estimate a measurement value (a value such as volume or diameter) relating to the shape of the left atrium or an attribute value (a value indicating the blood flow state, etc.) relating to the state of the left atrium on the basis of the detailed region.

As described above, according to the image processing apparatus 100 of the present embodiment, a plurality of initial regions of the heart cavity can be acquired by using a plurality of three-dimensional images obtained by imaging the heart of the subject, and a detailed region of the heart cavity can be acquired by using a predetermined three-dimensional image on the basis of the plurality of initial regions acquired. The user of the image processing apparatus 100 can check the acquired detailed region of the heart cavity and measurement values measured from the detailed region of the heart cavity, and understand the structure and state of the heart of the subject more easily and accurately than before.

Next, a modification of the first embodiment will be described. In the following description, components and processes similar to those of the image processing system 10 according to the first embodiment are denoted by the same reference numerals, and detailed description thereof is omitted.

### Modification 1

In the above image processing apparatus 100 according to the first embodiment, the detailed region acquired in step S340 is output to the display control unit 250. In the image processing apparatus 100 according to the present modification, however, the detailed region acquisition unit 240 outputs the detailed region of the left atrium of a predetermined image acquired in step S340 to the initial region acquisition unit 220, for example. Then, the initial region acquisition unit 220 may substitute the detailed region input from the detailed region acquisition unit 240 for the initial regions and execute the process in step S320 again.

As a specific example, it is assumed that the image by using which a detailed region is acquired in step S340 is the image 410 illustrated in FIG. 4D. In this case, in step S320, the initial region acquisition unit 220 replaces the initial region 411 acquired by using the image 410 with the detailed region. This allows the initial region acquisition unit 220 to acquire the initial region as a region from which an object (such as the left atrium) can be specified with higher accuracy. Thus, according to the present modification, it can be expected that, in step S340, the detailed region acquisition unit 240 can acquire information about the detailed region that is more accurate than the detailed region acquired first.

In the image processing apparatus 100 of the present modification, when acquiring a detailed region by executing step S340 again after substituting the detailed region for the initial region in step S320, it is not necessary to acquire a detailed region by using the same image as that used in the preceding step S340. For example, in the case of a 4D CT image obtained by imaging a pulsating heart over time, the control unit 115 acquires a detailed region by using an image of a first frame in the first step S340. In the subsequent step S320, the control unit 115 replaces an initial region acquired in the image of the first frame with the acquired detailed region. Then, in the next step S340, the control unit 115 acquires a detailed region by using an image of a frame (second frame) continuous with the image of the first frame that is used in the preceding step S340. Further, in the subsequent step S320, the control unit 115 replaces an initial region acquired in the image of the second frame with the acquired detailed region. Then, the control unit 115 may repeatedly execute the processes from step S320 to step S340 until a detailed region is acquired for images of all the frames acquired by the input image acquisition unit 210.

Thus, according to the image processing apparatus 100 according to the present modification, the information about the detailed region can be more accurately acquired by using a predetermined three-dimensional image using, as the initial region, a region in which the accuracy of extracting the object from the plurality of three-dimensional images acquired by the input image acquisition unit 210 is higher.

### Modification 2

Next, a second modification of the first embodiment will be described. The image processing apparatus 100 according to the first embodiment acquires a detailed region of the left atrium which is a cavity of the heart. However, the image processing apparatus 100 according to the present modification can acquire a detailed region for an organ other than the heart.

As an example of the present modification, it is assumed that the image processing apparatus 100 processes a dynamic CT image obtained by imaging the liver. In contrast CT images of the liver, an image of a phase (e.g., an arterial phase) with a short time lapse from administration of a contrast agent to the subject has a large difference in CT values between the liver and the surrounding blood vessels, and therefore the image processing apparatus 100 has a tendency to extract an initial region near the boundary between the liver and the blood vessels with high accuracy. On the other hand, there is a small difference in CT values between the liver parenchyma and the surrounding soft tissue, and therefore the image processing apparatus 100 has a tendency to extract an initial region near the boundary between the liver and the surrounding soft tissue with low accuracy.

Meanwhile, an image of a phase (e.g., a portal phase or an equilibrium phase) with a long time lapse from administration of a contrast agent to the subject has a small difference in CT values between the liver and the surrounding blood vessels, and therefore the image processing apparatus 100 has a tendency to extract an initial region near the boundary between the liver and the blood vessels with low accuracy. On the other hand, there is a large difference in CT values between the liver parenchyma and the surrounding soft tissue, and therefore the image processing apparatus 100 has a tendency to extract an initial region near the boundary between the liver and the surrounding soft tissue with high accuracy.

In the image processing apparatus 100, a region in which initial regions acquired by using each of an image of a phase with a short time lapse and an image of a phase with a long time lapse from administration of a contrast agent to the subject overlap is acquired. This allows the image processing apparatus 100 to exclude a region overextracted near the boundary between the liver and the surrounding blood vessels or soft tissue. That is, the image processing apparatus 100 according to the present modification is expected to have the effect that a region having a high probability (likelihood) of being inside of the liver can be acquired as the foreground seed. Further, the image processing apparatus 100 according to the present modification is expected to have the effect that a region having a high probability (likelihood) of being outside of the liver, excluding a missing region near the boundary between the liver and the surrounding blood vessels or soft tissue, can be acquired as the background seed.

While a detailed region is acquired for the liver, which is different from the heart cavity of the first embodiment, in the description of the present modification, a detailed region may be acquired for another site (e.g., the lungs) of the subject, or for a site of an object (e.g., an industrial member) other than the human body.

Thus, according to the image processing apparatus 100 according to the present modification, a detailed region can be acquired by using the plurality of three-dimensional images acquired by the input image acquisition unit 210 for various sites of the subject or objects other than the human body.

Note that the above-described various types of control performed by the control unit 115 may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the technique of the present disclosure, it is possible to improve the accuracy in extracting a region related to a site of a subject from an image obtained by imaging the site.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-042589, filed on Mar. 18, 2024, which is hereby incorporated by reference herein in its entirety.

What is claimed is:

1. An image processing apparatus comprising:
a processor; and
a memory storing a program which, when executed by the processor, causes the image processing apparatus to
execute image acquisition processing of acquiring a plurality of images in which a site of a subject is imaged,
execute initial region acquisition processing of acquiring information about a plurality of initial regions associated with the site by using a number of images among the plurality of images, and execute detailed region acquisition processing of acquiring information about a detailed region associated with the site in any of the plurality of images on the basis of the information about the plurality of initial regions.

2. The image processing apparatus according to claim 1, wherein in the detailed region acquisition processing, the detailed region is acquired such that a probability that the site is included inside of the region is higher than that each of the initial regions and a probability that the site is included outside of the region is lower than that each of the initial regions.

3. An image processing apparatus comprising:
a processor; and
a memory storing a program which, when executed by the processor, causes the image processing apparatus to
execute image acquisition processing of acquiring a plurality of images in which a site of a subject is imaged,
execute first information acquisition processing of acquiring information about a plurality of first regions associated with the site by using a number of images among the plurality of images, and
execute second information acquisition processing of acquiring information about a second region on the basis of the information about the plurality of first regions, the second region associated with the site in any of the plurality of images and being higher in a degree of coincidence with a shape of the site than the first regions.

4. The image processing apparatus according to claim 3, wherein in the first information acquisition processing, a first likelihood distribution of a likelihood of being a region of the site is acquired by using the number of images, and the information about each of the first regions is acquired on the basis of the first likelihood distribution.

5. The image processing apparatus according to claim 4, wherein in the first likelihood distribution, a likelihood for an overlapping portion between at least two regions of the plurality of first regions is higher than a likelihood for a non-overlapping portion between the at least two regions.

6. The image processing apparatus according to claim 4, wherein in the first information acquisition processing, information about a portion in which a likelihood in the first likelihood distribution is equal to or greater than a threshold is acquired as the information about each of the first regions.

7. The image processing apparatus according to claim 3, wherein in the first information acquisition processing, a second likelihood distribution of a likelihood of being a region outside of the site is acquired by using the number of images, and the information about each of the first regions is acquired on the basis of the second likelihood distribution.

8. The image processing apparatus according to claim 7, wherein in the second likelihood distribution, a likelihood for a portion not included in any of at least two regions of the plurality of first regions is higher than a likelihood for a portion included in any of the at least two regions.

9. The image processing apparatus according to claim 7, wherein in the first information acquisition processing, information about a region outside of the site in which a likelihood in the second likelihood distribution is equal to or greater than a threshold is acquired as the information about each of the first regions.

10. The image processing apparatus according to claim 3, wherein the program, when executed by the processor, further causes the image processing apparatus to execute image selection processing of selecting two or more images, by using which the information about the first regions is acquired by the first information acquisition processing, by using the plurality of images acquired by the image acquisition processing.

11. The image processing apparatus according to claim 10, wherein in the image selection processing, the two or more images are selected on the basis of form information or phase information on the site in the plurality of images acquired by the image acquisition processing.

12. The image processing apparatus according to claim 3, wherein the plurality of images acquired by the image acquisition processing include a plurality of images in which the site of the subject is imaged over time.

13. The image processing apparatus according to claim 3, wherein:
the plurality of images include an image associated with different phases of the site whose shape changes periodically; and
in the first information acquisition processing, the information about each of the first regions is acquired by using an image of the site associated with a predetermined phase among the plurality of images.

14. The image processing apparatus according to claim 13, wherein in the first information acquisition processing, the information about each of the first regions is acquired by changing a shape of a region associated with the site in the image associated with the predetermined phase.

15. An image processing method comprising:
acquiring a plurality of images in which a site of a subject is imaged;
acquiring information about a plurality of initial regions associated with the site by using a number of images of the plurality of images; and
acquiring information about a detailed region associated with the site in any of the plurality of images on the basis of the information about the plurality of initial regions.

16. An image processing method comprising:
acquiring a plurality of images in which a site of a subject is imaged;
acquiring information about a plurality of first regions associated with the site by using a number of images of the plurality of images; and
acquiring information about a second region on the basis of the information about the plurality of first regions, the second region associated with the site in any of the plurality of images and being higher in a degree of coincidence with a shape of the site than the first regions.

17. A non-transitory computer readable medium that stores a program, wherein the program causes a computer to execute each step in the image processing method according to claim 15.

18. A non-transitory computer readable medium that stores a program, wherein the program causes a computer to execute each step in the image processing method according to claim 16.
